(19) United States
(12) Patent Application Publication
(10) Pub. No.: US 2018/0242247 A1
(43) Pub. Date: Aug. 23, 2018

(54) CHANGING METHOD FROM SLEEP MODE TO AWAKE MODE IN WIFI SYSTEM

(71) Applicant: FCI INC, Gyeonggi-do (KR)

(72) Inventors: Hyungil GOH, Gyeonggi-do (KR); Beomjin KIM, Gyeonggi-do (KR)

(21) Appl. No.: 15/435,918

(22) Filed: Feb. 17, 2017

(51) Int. Cl. H04W 52/02

(52) U.S. Cl. CPC H04W 52/0229; H04W 84/12

(57) ABSTRACT

A method of changing from a Sleep mode to an Awake mode in a WIFI system includes (a) performing a TIM or DTIM inspection by using an auxiliary application, (b) performing Power-Down when no data to receive exists as a result of the inspection in the operation (a), and (c) changing to the Awake mode by using a main application when data to receive exists as a result of the inspection in the operation (a). According to the method of changing from a Sleep mode to an Awake mode in a WIFI system, power consumption may be minimized by dualizing an application and using an auxiliary application including only essential functions for TIM/DTIM inspection, separately from a main application.

### BACKGROUND OF THE INVENTION

### Field of Invention

The present disclosure relates to a method of changing from a Sleep mode to an Awake mode in a WIFI system, and more particularly, to a method of changing from a Sleep mode to an Awake mode in a WIFI system, by which a TIM (Traffic Indication Message) or a DTIM (Delivery TIM) is inspected in a low power mode by using two different applications.

### Description of Prior Art

FIG. 1 is a view describing a conventional power management model in the 802.11 WLAN.

In the conventional power management model in the 802.11 WLAN, when there is no more data to transmit or receive in an Awake mode state, a Sleep mode state is entered for low power consumption. In the Sleep mode state, a TIM (Traffic Indication Message) or a DTIM (Delivery TIM), which is information in a Beacon Frame transmitted in a constant cycle, is inspected to check the existence of data to receive. As a result of the inspection, if there is data to receive, the mode state is switched to the Awake mode state, and PS-Poll is transmitted and data is received. In addition, if there is no data to receive as a result of the inspection, the Sleep mode state is maintained.

In detail, the conventional power management model in the 802.11 WLAN implements a WIFI system for low power consumption as follows.

In the Sleep mode state, Power-Down is performed to minimize power consumption. For Power-Down, necessary information such as Association, Authentication, and the like is managed by being stored in a retained memory. In addition, after a timer using RTC (Real Time Clock) is set to wake up in a TIM or DTIM receiving section, a Power-Down mode is entered. Furthermore, a Power-Up mode is entered by the wakeup through the RTC, and then, an initialization process or booting to receive a Beacon Frame is performed.

FIG. 2 is an exemplary view showing consumption of power for each level in the conventional power management model in the 802.11 WLAN.

In order to enter the Awake mode state from the Sleep mode, that is, in Doze state, one main application has been conventionally used. Accordingly, according to the conventional power management model in the 802.11 WLAN, considerable Booting time is required in the Wakeup process, and moreover, a plurality of initialization processes for overall system operation, such as, a MAC protocol and overall Protocol stack initialization process and an initialization process on internal Peripheral devices and external devices, need to be performed.

In other words, according to the conventional power management model in the 802.11 WLAN, the one main application needs to be mounted with all functions to service. In detail, one main application is additionally provided with service related codes and data, in addition to essential codes and data needed for TIM/DTIM inspection. Accordingly, since initialization processes for the added services are performed, unnecessary initialization time increases and hardware modules interacting with services are in a Power-Up state so that unnecessary power consumption is accompanied.

### SUMMARY OF THE INVENTION

It is an object of the present disclosure to provide a method of changing from a Sleep mode to an Awake mode in a WIFI system, by which power consumption may be minimized by dualizing an application and using an auxiliary application including only essential functions for TIM/DTIM inspection, separately from a main application.

In accordance with one aspect of the present disclosure, a method of changing from a Sleep mode to an Awake mode in a WIFI system includes (a) performing a TIM or DTIM inspection by using an auxiliary application; (b) performing Power-Down when no data to receive exists as a result of the inspection in the operation (a); and (c) changing to the Awake mode by using a main application when data to receive exists as a result of the inspection in the operation (a).

In detail, the method may further include, before the operation (a): waking up from a Sleep mode state by using RTC (Real Time Clock); initializing memory to inspect TIM or DTIM; and receiving a Beacon Frame.

In addition, the auxiliary application and the main application may be stored in different storage media. In detail, the auxiliary application may be stored in ROM (Read Only Memory).

Also, only some of functional blocks powered on in the operation (c) may be powered on in the operation (a).

The method may further include: loading and initializing the main application, between the operation (a) and the operation (c), when data to receive exists as a result of the inspection of the operation (a); and initializing at least some functional blocks of the WIFI system by using the main application.

In addition, the operation (c) may be performed by transmitting PS-Poll.

In accordance with another aspect of the present disclosure, a method of changing from a Sleep mode to an Awake mode in a WIFI system includes: a first step for determining whether to maintain the Sleep mode, by using an auxiliary application; and a second step for changing to the Awake mode, by using a main application. The auxiliary application may perform a TIM or DTIM inspection.

In addition, in the first step, when data to receive exists by inspecting the TIM or DTIM by using the auxiliary application, the second step may be performed. Only some of functional blocks powered on in the second step may be powered on in the first step. The second step may be performed by transmitting PS-Poll.

According to a method of changing from a Sleep mode to an Awake mode in a WIFI system of the present disclosure, power consumption may be minimized by dualizing an application and using an auxiliary application including only essential functions for TIM/DTIM inspection, separately from a main application.

### BRIEF DESCRIPTION OF THE DRAWINGS

FIG. 1 is a view for explaining a conventional power management model in the 802.11 WLAN.

FIG. 2 is an exemplary view showing consumption of power for each level in the conventional power management model in the 802.11 WLAN.

FIG. 3 is a flowchart of a method of changing from a Sleep mode to an Awake mode in a WIFI system according to an embodiment of the present disclosure.

FIGS. 4A and 4B are exemplary views showing consumption of power for each level in a WIFI system, according to the method of changing from a Sleep mode to an Awake mode in a WIFI system of the present disclosure.

FIG. 5 is a view indicating a power optimized part according to the present disclosure in comparison with the conventional power management model in the 802.11 WLAN.

FIG. 6 is a comparison view of power consumption between the conventional power management model in the 802.11 WLAN and the present disclosure.

FIG. 7 shows a block diagram of a WIFI system according to a preferred embodiment of the present invention.

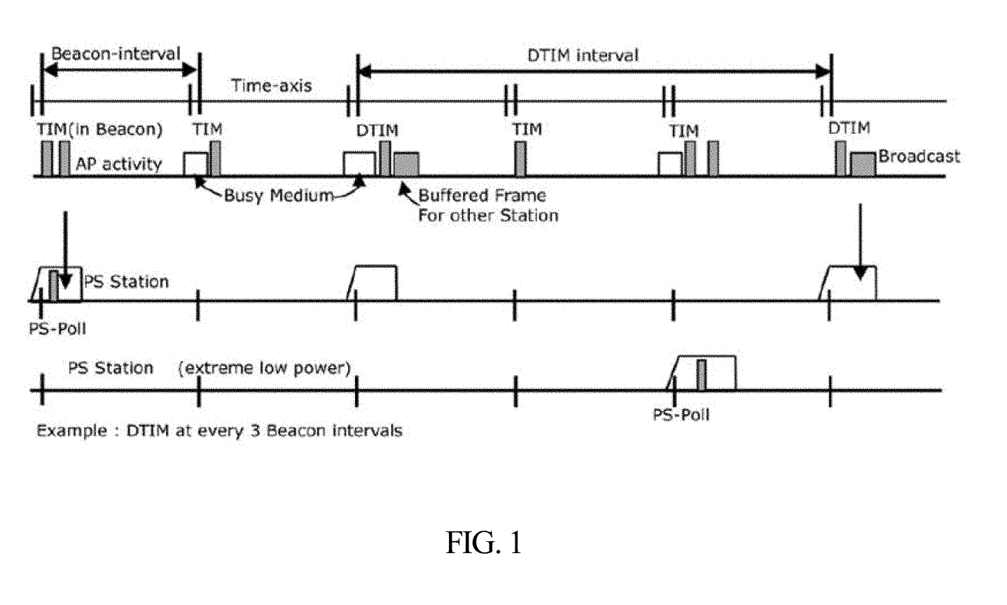

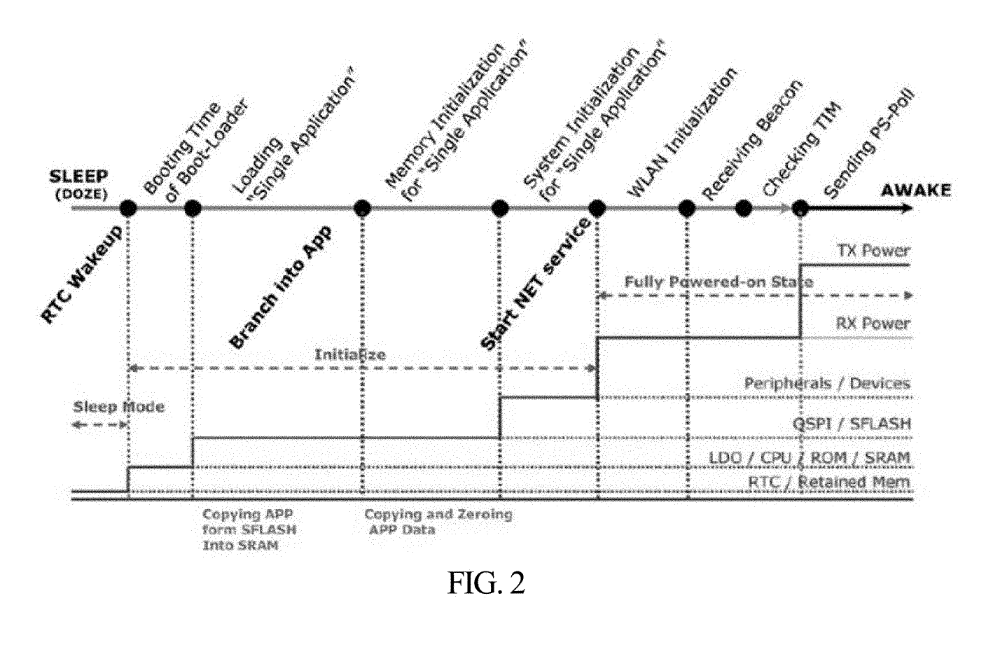

### DETAILED DESCRIPTION OF THE PREFERRED EMBODIMENTS

Hereinafter, a method of changing from a Sleep mode to an Awake mode of the WIFI system according to embodiments of the present disclosure will be described in detail with reference to the accompanying drawings.

It should be understood that the following embodiments of the present disclosure are intended to specify the present disclosure only and not to limit the scope of rights of the present disclosure. What those skilled in the art to which the present disclosure belongs can easily understand from the detailed description and the embodiments of the present disclosure can be construed to belong to the scope of the present disclosure.

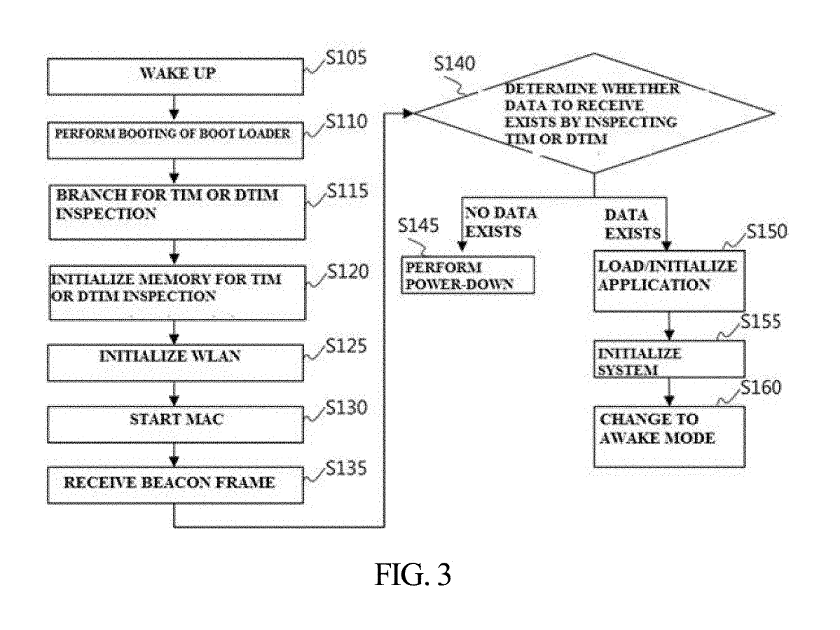

FIG. 3 is a flowchart of a method of changing from a Sleep mode to an Awake mode in a WIFI system according to an embodiment of the present disclosure.

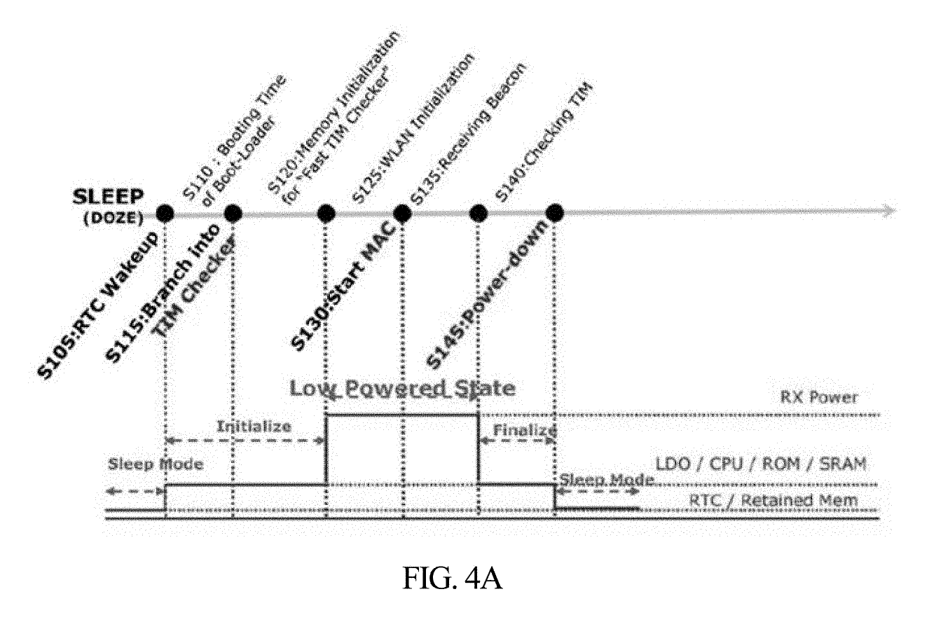

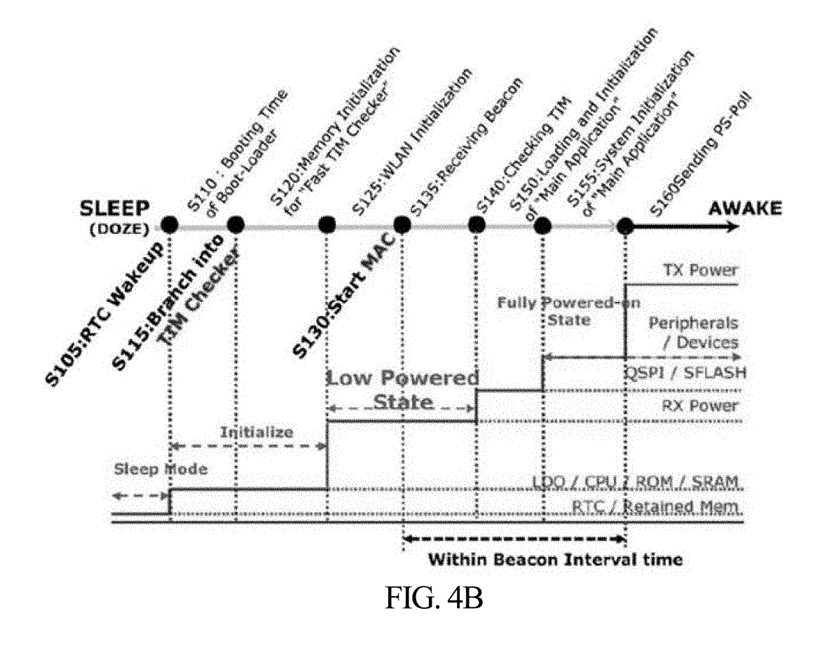

In addition, FIGS. 4A and 4B are exemplary views showing consumption of power for each level in a WIFI system, according to the method of changing from a Sleep mode to an Awake mode in a WIFI system of the present disclosure, respectively. In detail, FIG. 4A illustrates a case in which no data to receive exists as a result of a TIM (Traffic Indication Message) or a DTIM (Delivery TIM) inspection. FIG. 4B illustrates a case in which data to receive exists as a result of the TIM/DTIM inspection.

A method of changing from a Sleep mode to an Awake mode in a WIFI system of the present disclosure may include waking up from the Sleep mode state by using RTC (Real Time Clock) (S105), booting a Boot-Loader (S110), branching for a TIM or DTIM inspection (S115), initializing memory for the TIM or DTIM inspection (S120), and initializing WLAN (S125).

For reference, in the method of changing from the Sleep mode to the Awake mode in the WIFI system of the present disclosure, like the conventional power management model in the 802.11 WLAN, Power-Down is performed to minimize power consumption in the Sleep mode state. For the Power-Down, necessary information such as Association and Authentication is managed by being stored in a Retained Memory. In addition, after a Timer is set by using RTC to wake up in a TIM or DTIM receiving section, a Power-Down mode is entered. Furthermore, the Power-Up mode is entered by the waking up using RTC (S105).

In addition, the method of changing from a Sleep mode to an Awake mode in a WIFI system of the present disclosure may further include starting MAC (Medium Access Control) (S130), receiving a Beacon Frame (S135), inspecting the TIM or DTIM in the Beacon Frame by using an auxiliary application (S140), and performing Power-Down when no data to receive exists as a result of the inspection of the operation S140 (S145).

Furthermore, the method of changing from a Sleep mode to an Awake mode in a WIFI system of the present disclosure may further include loading and initializing a main application when data to receive exists as a result of the inspection of the operation S140 (S150), initializing at least some functional blocks of the WIFI system by using the main application (S155), and changing to the Awake mode by using the main application, by transmitting PS-Poll (S160).

In the method of changing from a Sleep mode to an Awake mode in a WIFI system of the present disclosure, in the WIFI system, the auxiliary application and the main application are stored in different storage media. In detail, the auxiliary application is stored in ROM (Read Only Memory) so as to require shorter loading time.

In addition, prior to the operation S105, that is, in the Sleep mode state, for the RTC and Power-Down of the WIFI system, the retained memory storing necessary information such as Association and Authentication is powered on (Power-On). In addition, after the operation S105, a LDO (Low-Dropout Regulator), a main processor (CPU), ROM, and SRAM of the WIFI system are powered on. Although Rx power is on after the operation S125, the Rx power is off again after the operation S140.

When the system returns back to the Sleep mode state by the operation S145, the LDO, the main processor (CPU), the ROM, and the SRAM of the WIFI system are powered off and thus only the power of the RTC and the retained memory are maintained in an ON state.

Furthermore, after the operation S150, QSPI and SFLASH are powered on. In addition, after the operation S155, other peripheral devices (Peripheral) and devices are powered on, and after the operation S160, Tx power is on.

In other words, according to a method of changing from a Sleep mode to an Awake mode in a WIFI system of the present disclosure, it may be seen that only some of the functional blocks powered on in the operations S150 to S160 are powered on in the operations S105 to S145.

In summary, the method of changing from a Sleep mode to an Awake mode in a WIFI system of the present disclosure may be implemented largely by two steps.

In detail, the first step may include the operations S105 to S145, in which whether to maintain the Sleep mode is determined by using the auxiliary application. The second step may include the operations S150 to S160, to change to the Awake mode by using the main application. The determining of whether to maintain the Sleep mode in the first step may be performed by inspecting the TIM or DTIM.

In the first step, only the essential functional blocks such as the RTC, the main processor (CPU), the ROM, the SRAM, and a RF/WLAN Controller are powered on by the auxiliary application, and some of MAC protocols, a Beacon Parser, the TIM/DTIM inspection only may be performed. Accordingly, the auxiliary application is included in the ROM so as not to require the Loading Time.

In addition, in the second step, the same services performed by one main application in the conventional power management model in the 802.11 WLAN are all supported.

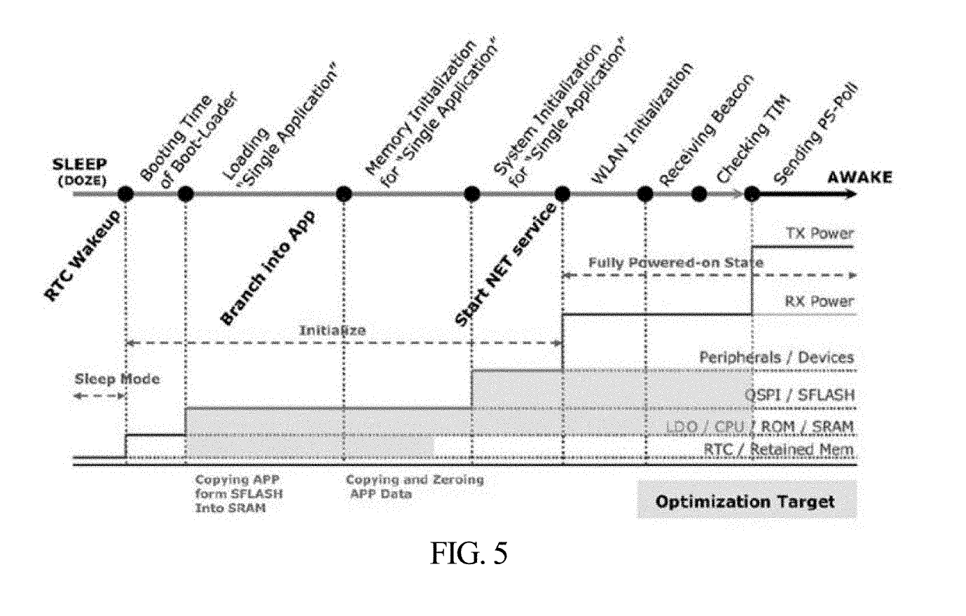

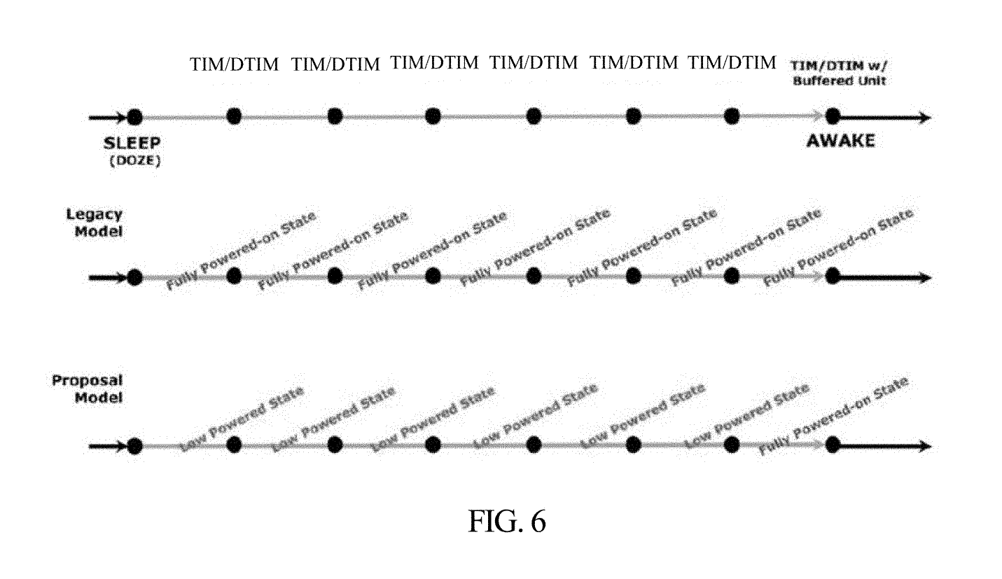

FIG. 5 is a view indicating a power optimized part according to the present disclosure in comparison with the conventional power management model in the 802.11 WLAN. In addition, FIG. 6 is a comparison view of power consumption between the conventional power management model in the 802.11 WLAN and the present disclosure.

As can be seen from FIGS. 5 and 6, according to the present disclosure, although entering the Awake mode state from Sleep mode state may be possibly delayed, power consumption for the TIM/DTIM inspection may be minimized

In an N-numbered TIM/DTIM section, when data is received and Awake is needed, power consumption P1 according to the conventional model and power consumption P2 according to the present disclosure may be expressed by [Equation 1] and [Equation 2] below.

P1=N×(Fully Powered-on State) [Equation 1]

P2=(N−1)×(Low Powered Stage)+1×(Fully Powered-on State) [Equation 2]

In other words, according to the present disclosure, the power consumption is reduced compared to the conventional model so that a long battery life span may be expected.

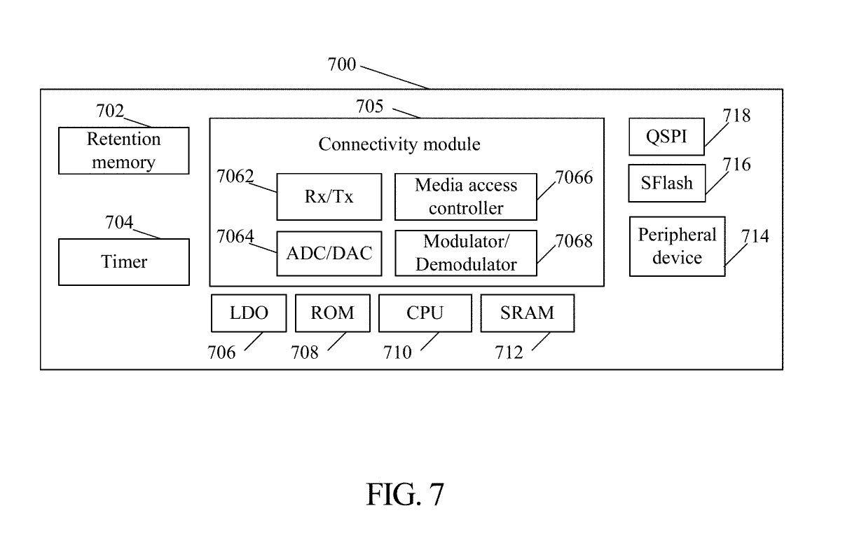

FIG. 7 shows a block diagram of a WIFI system 700 according to a preferred embodiment of the present invention. The WIFI system 700 comprises a retained memory 702, a timer 704, a connectivity module 705, a LDO (Low-Dropout Regulator) 706, a ROM 708, a CPU 710, a SRAM 712, a QSPI 718, a SFlash 716, and a peripheral device 714. The connectivity module 706 is used for connecting to an AP on interne when powering on by using specific wireless technology standards, such as WiFi, Bluetooth, Zigbee, and ZWAVE. The connectivity module 706 further comprises a Rx/Tx 7062, a media access controller 7066, a ADC/DAC 7064 and a Modulator/Demodulator 7068. The peripheral device 714 can be a Universal Serial Bus (USB) device, a screen, a keyboard, or a speaker, but the invention is not limited thereof.

For improving power efficiency, an auxiliary application is stored in ROM 708 and the auxiliary application is used to power on the connectivity module 705, the LDO (Low-Dropout Regulator) 706, the ROM 708, the CPU 710, the SRAM 712, to receive TIM/DTIM and do inspection in the first step. By utilizing the auxiliary application, the wifi system 700 can reduce power consumption without power on the QSPI 718, the SFlash 716, and the peripheral device 714. The QSPI 718, the SFlash 716, and the peripheral device 714 will be powered on in the second step if needed.

As described above, according to the method of changing from a Sleep mode to an Awake mode in a WIFI system of the present disclosure, it may be seen that power consumption may be minimized by dualizing an application and using an auxiliary application including only essential functions for TIM/DTIM inspection, separately from a main application.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A method of changing from a Sleep mode to an Awake mode in a WIFI system, the method comprising:
(a) performing a TIM or DTIM inspection by using an auxiliary application;
(b) performing Power-Down when no data to receive exists as a result of the inspection in the operation (a); and
(c) changing to the Awake mode by using a main application when data to receive exists as a result of the inspection in the operation (a).

2. The method of claim 1, further comprising, before the operation (a):
waking up from a Sleep mode state by using RTC (Real Time Clock);
initializing memory to inspect TIM or DTIM; and
receiving a Beacon Frame.

3. The method of claim 1, wherein the auxiliary application and the main application are stored in different storage media.

4. The method of claim 1, wherein the auxiliary application is stored in ROM (Read Only Memory).

5. The method of claim 1, wherein a connectivity module, a LDO (Low-Dropout Regulator), a ROM, a CPU, and a SRAM are powered by the auxiliary application to perform the TIM or DTIM inspection.

6. The method of claim 1, further comprising:
loading and initializing the main application, between the operation (a) and the operation (c), when data to receive exists as a result of the inspection of the operation (a); and
initializing a SFlash and a QSPI of the WIFI system by using the main application.

7. The method of claim 1, wherein the operation (c) is performed by transmitting PS-Poll.

8. A method of changing from a Sleep mode to an Awake mode in a WIFI system, the method comprising:
a first step for determining whether to maintain the Sleep mode, by using an auxiliary application; and
a second step for changing to the Awake mode, by using a main application.

9. The method of claim 8, wherein the auxiliary application performs a TIM or DTIM inspection.

10. The method of claim 9, wherein, in the first step, when data to receive exists by inspecting the TIM or DTIM by using the auxiliary application, the second step is performed.

11. The method of claim 8, wherein the auxiliary application and the main application are stored in different storage media.

12. The method of claim 8, wherein the auxiliary application is stored in ROM (Read Only Memory).

13. The method of claim 9, wherein a connectivity module, a LDO (Low-Dropout Regulator), a ROM, a CPU, and a SRAM are powered by the auxiliary application to perform the TIM or DTIM inspection.

14. The method of claim 8, wherein the second step is performed by transmitting PS-Poll.

15. The method of claim 8, wherein a QSPI and a SFlash are power off in the first step.
